(19) United States
(12) Patent Application Publication
(10) Pub. No.: US 2021/0189267 A1
(43) Pub. Date: Jun. 24, 2021

(54) METHOD AND DEVICE FOR VISCOSITY-REDUCING AND UPGRADING OF LOW-GRADE HEAVY OIL

(71) Applicant: PetroChina Company Limited, Beijing (CN)

(72) Inventors: QINGFENG TAN, Beijing City (CN); AN MA, Beijing City (CN); CHANGLU HU, Beijing City (CN); LUHAI WANG, Beijing City (CN); TAO CHENG, Beijing City (CN); LITAO WANG, Beijing City (CN); DONGHAO YANG, Beijing City (CN); YINDONG LIU, Beijing City (CN); YAN WANG, Beijing City (CN); SHUANG HAN, Beijing City (CN); XIAO ZHANG, Beijing City (CN); YINGCHUN LIANG, Beijing City (CN); HANG YANG, Beijing City (CN); JUNNAN SONG, Beijing City (CN); HUILING YOU, Beijing City (CN); JINGMAN LU, Beijing City (CN); BOHAN ZHANG, Beijing City (CN); WU SU, Beijing City (CN)

(21) Appl. No.: 17/083,638

(22) Filed: Oct. 29, 2020

(30) Foreign Application Priority Data
Dec. 23, 2019 (CN) 201911333626.3

(51) Int. Cl. C10G 69/06; B01J 8/04; B01D 3/14

(52) U.S. Cl. CPC C10G 69/06; B01J 8/0492; B01D 3/14; C10G 2300/107; C10G 2300/1077; C10G 2300/205; C10G 2300/4012; C10G 2300/301; C10G 2300/4018; C10G 2300/302; C10G 2300/308; C10G 2300/4006

(57) ABSTRACT

Provided is a method and device for viscosity-reducing and upgrading of low-grade heavy oil. The method comprises: (a) performing visbreaking reaction on low-grade heavy oil raw material and controlling the content of toluene insolubles in the produced oil; (b) mixing the produced oil in step (a) with hydrogen in a gas-liquid mixer to obtain a hydrogen-oil mixture in liquid state, or mixing the produced oil in step (a) with hydrogen to obtain hydrogen-oil mixture in gas-liquid state; in the presence of a hydrogenation catalyst, performing hydrogenation reaction on the hydrogen-oil mixture in liquid state or the hydrogen-oil mixture in gas-liquid state in the reactor, and obtaining a viscosity-reduced and upgraded oil after the reaction. It is viscosity-reducing and upgrading method by combining thermal visbreaking and fixed-bed hydrogenation, which can solve the problems of high viscosity, high density and poor stability of low-grade heavy oil products in the prior art.

### CROSS-REFERENCE TO RELATED APPLICATIONS

This application claims priority from Chinese Patent Application No. 201911333626.3, filed on Dec. 23, 2019, the disclosure of which is incorporated by reference herein.

### TECHNICAL FIELD

The disclosure relates to method and device for viscosity-reducing and upgrading of low-grade heavy oil, which belongs to the technical field of unconventional petroleum modification and utilization.

### BACKGROUND ART

With the declining of conventional petroleum resources in the world and the increase of proven reserves of unconventional petroleum resources, especially the development of low-grade heavy oil mining technology, low-grade heavy oil has become an important choice for the imported petroleum of China. With the increasing production of low-grade heavy oil, it is facing a more urgent and important problem, namely, how to transform low-grade heavy oil with high viscosity and poor fluidity into a lower viscosity fluid that is easy to transport.

Chinese patent CN102287174A discloses a method for breaking and viscosity-reducing of salt-containing heavy oil on the surface of an oil field. In this method, superheated steam and salt-resistant catalysts are used to thermally crack the salt-containing heavy oil, in order to achieve an irreversible reduction of the viscosity of the heavy oil. In this method, the breaking reaction time (0.5 to 4.0 h) in the modification and viscosity-reducing tower is long, which will inevitably lead to a large volume of the reaction tower, which may require a large number of reaction towers and is not conducive to the modification treatment of a large amount of heavy oil.

Chinese patent CN106883873A discloses a method for improving the API degree by modification of low-grade heavy oil. In this method, vacuum residuum and straight-run distillate oil containing hydrogen donor fraction are produced by atmospheric and vacuum distillation. The vacuum residuum and all or part of the hydrogen donor fraction are mixed to perform hydrogen-donating thermal breaking reaction, and the resulting residual oil enters a solvent deasphalting device to remove asphalt. The obtained deasphalted oil is mixed with the remaining straight-run distillate oil and hydrogen-supply thermal breaking distillate oil to produce modified oil with an API degree greater than 19. This method produces some low-value deoiled asphalt products, which reduces the yield of liquid oil products.

Chinese patent CN102653675A discloses a method for hydrothermal catalytic viscosity-reducing and upgrading of heavy oil. In this method, one or more of 2,4-hexanedione, acetylacetone, ethyl acetoacetate and diethyl malonate are selected as auxiliary agents. After the reaction of heavy oil, water, catalysts and auxiliary agents under certain conditions, the viscosity and density of heavy oil are significantly reduced. This method uses chemicals that consume higher prices, which reduces the economy.

Chinese Patent CN106089167A discloses a method for underground catalytic viscosity-reducing and upgrading of heavy oil. The method uses iron-sulfur cluster compounds as catalysts. Specifically, one or a combination of tetraethylthio diferric tetraethylammonium disulfide, tetraethylthio triferric tetraethylammonium tetrasulfide, tetraethylthio tetraferric tetraethylammonium tetrasulfide is used as a catalyst to reduce the viscosity of heavy oil through catalytic breaking reaction or hydrogen supply catalytic breaking reaction. The iron and sulfur cluster compounds used in this method are difficult to synthesize and expensive, which affects the practical value of this method.

Chinese patent CN102654047A discloses an integrated method of hydrothermal catalytic viscosity-reducing and upgrading, production and transportation of heavy oil. In this method, the produced diluted heavy oil is modified by reaction under the conditions of water, catalyst and additives. Some part of the viscosity-reduced and upgraded oil is transported outward, and the other part is returned to the wellbore to participate in oil recovery. The catalysts used in this method included one or more of molybdenum, iron, nickel, cobalt and vanadium. This method increases the metal content in the heavy oil during the modification process, which is not conducive to the subsequent refining process.

Chinese patent CN101649734A discloses an integrated method of catalytic viscosity-reducing and upgrading, production and transportation of heavy oil. In this method, thin oil is introduced into the wellbore at a mass ratio of 0.4-1.0 to the heavy oil to reduce the viscosity of the heavy oil, and the thin heavy oil is produced. The produced dilute heavy oil is fractionated in the distillation tower to distill the fraction below 350° C., which is injected into the wellbore for recycling, and the fraction above 350° C. enters the reaction tower. Under the action of the modification catalyst, it is catalytically upgraded to low-viscosity heavy oil and then directly transported outward. The modification catalyst used in this method is one of iron oleate, nickel oleate, copper oleate, zinc oleate or nickel chloride. The method increases the content of iron, nickel, copper or zinc in the heavy oil, which is not conducive to the subsequent oil refining process.

Chinese patent CN106147843A discloses a viscosity-reducing and upgrading method of heavy oil and application. In this method, the gas and straight-run light distillate oil are firstly removed from the heavy oil raw material in a distillation device to obtain a distillate with an API degree of less than 7. The distillate undergoes a hydrogenation reaction in a fluidized-bed reactor, and the obtained liquid product is fractionated in a fractionation column to obtain gas, light distillate oil and hydrogenated tail oil. The hydrogenation tail oil is returned to the fluidized-bed reactor, and one or more of the straight-run light distillate oil, the fluidized-bed hydrogenated light distillate oil and the heavy oil raw material are blended to a viscosity-reduced and upgraded oil with an API degree of 12 or higher in a blending device. The investment and construction cost of the fluidized-bed reactor is relatively high, and the operation process is relatively complicated, which is not conducive to the practical application of the method.

Chinese patent CN106147837A discloses a viscosity-reducing and upgrading method of heavy oil and application. In this method, the gas and straight-run light distillate oil are firstly removed from the heavy oil raw material in a distillation device to obtain a distillate with an API degree of less than 8. The distillate undergoes a hydrogenation reaction in a fixed-bed reactor, and the obtained liquid product is fractionated in a fractionation column to obtain gas, light distillate oil and hydrogenated tail oil. The hydrogenation tail oil is returned to the fixed-bed reactor, and one or more of the straight-run light distillate oil, the fixed-bed hydrogenated light distillate oil and the heavy oil raw material are blended to a viscosity-reduced and upgraded oil with an API degree of 12 or higher in a blending device. The fixed-bed hydrogenation is difficult to process low-grade raw material and its conversion rate is limited. This determines that the degree of viscosity reduction by using this method is limited, which is not conducive to the application of this method to viscosity-reducing and upgrading of low-grade heavy oil.

Chinese patent CN106147836A discloses a viscosity-reducing and upgrading method of heavy oil and application. In this method, the gas and straight-nm light distillate oil are firstly removed from the heavy oil raw material in a distillation device to obtain a distillate with an API degree of less than 7. The distillate undergoes a hydrogenation reaction in a suspended-bed reactor, and the obtained liquid product is fractionated in a fractionation column to obtain gas, light distillate oil and hydrogenated tail oil. The hydrogenation tail oil is returned to the suspended-bed reactor, and one or more of the straight-run light distillate oil, the suspended-bed hydrogenated light distillate oil and the heavy oil raw material are blended to a viscosity-reduced and upgraded oil with an API degree of 12 or higher in a blending device. The investment and construction cost of the suspended-bed reactor is relatively high, and the operation process is relatively complicated, which is not conducive to the practical application of the method.

Chinese patent CN104695918A discloses a method for underground viscosity-reducing and upgrading of heavy oil. In this method, during the process of steam injection to develop heavy oil, amphiphilic catalysts and additives are injected into the formation along with steam, the oil layer temperature rises and the well is simmered for 1 to 5 days to promote the hydrothermal breaking reaction of the asphaltene and gum in the heavy components of the heavy oil. The method has a long reaction time for simmering wells, which will reduce the oil recovery efficiency. In addition, the amphiphilic catalyst used in the method contains nickel, which is not conducive to the subsequent refining and processing of heavy oil.

Therefore, providing a new method and device for viscosity-reducing and upgrading of low-grade heavy oil has become an urgent technical problem in this field.

### SUMMARY

In order to solve the above shortcomings and deficiencies, the present disclosure aims to provide a method and device for viscosity-reducing and upgrading of low-grade heavy oil. The method provided by the present disclosure is a viscosity-reducing and upgrading method combining thermal visbreaking and fixed-bed hydrogenation, which can solve the problems of high viscosity, high density and poor stability of low-grade heavy oil products in the prior art.

In order to achieve the above objectives, in an aspect, the present disclosure provides a method for viscosity-reducing and upgrading of low-grade heavy oil, wherein the method comprises:

(a) performing a visbreaking reaction on the low-grade heavy oil raw material and controlling the content of toluene insolubles in the produced oil;

(b) mixing the produced oil obtained in step (a) with hydrogen in a gas-liquid mixer to obtain a hydrogen-oil mixture in liquid state, or mixing the produced oil obtained in step (a) with hydrogen to obtain a hydrogen-oil mixture in gas-liquid state; in the presence of a hydrogenation catalyst, performing a hydrogenation reaction on the hydrogen-oil mixture in liquid state or the hydrogen-oil mixture in gas-liquid state in the reactor, and obtaining a viscosity-reduced and upgraded oil after the reaction.

In the above-mentioned method for viscosity-reducing and upgrading of low-grade heavy oil, preferably, in step (a), the low-grade heavy oil raw material includes at least one selected from the group consisting of heavy crude oil, oil sand bitumen, atmospheric residuum and vacuum residuum.

In the above-mentioned method for viscosity-reducing and upgrading of low-grade heavy oil, preferably, in step (a), the mass content of toluene insolubles in the produced oil (calculated based on the total weight of the produced oil) is controlled to be less than 1.0%.

In the above-mentioned method for viscosity-reducing and upgrading of low-grade heavy oil, more preferably, in step (a), the mass content of toluene insolubles in the produced oil is controlled to be less than 0.2%.

In the above-mentioned method for viscosity-reducing and upgrading of low-grade heavy oil, preferably, in step (a), the visbreaking reaction is thermal visbreaking reaction, and the operating process conditions are: a reaction temperature ranging from 360 to 500° C., a reaction pressure ranging from 0.1 to 6.0 MPa, a residence time ranging from 1 to 120 minutes, and a mass conversion rate of the visbreaking reaction ranging from 1 to 80%.

In the above-mentioned method for viscosity-reducing and upgrading of low-grade heavy oil, more preferably, in step (a), the visbreaking reaction is thermal visbreaking reaction, and the operating process conditions are: a reaction temperature ranging from 400 to 450° C., a reaction pressure ranging from 0.2 to 2.0 MPa, a residence time ranging from 3 to 60 minutes, and a mass conversion rate of the visbreaking reaction ranging from 5 to 50%.

In the above-mentioned method for viscosity-reducing and upgrading of low-grade heavy oil, in step (a), the content of toluene insolubles in the produced oil is usually controlled by changing the visbreaking reaction conditions.

Preferably, the above-mentioned method for viscosity-reducing and upgrading of low-grade heavy oil further comprises: fractionating the produced oil obtained in step (a) to obtain a light distillate oil and a heavy distillate oil; and then mixing the light distillate oil and hydrogen in a gas-liquid mixer to obtain a hydrogen-oil mixture in liquid state, or mixing the light distillate oil and hydrogen to obtain a hydrogen-oil mixture in gas-liquid state; in the presence of a hydrogenation catalyst, performing a hydrogenation reaction on the hydrogen-oil mixture in liquid state or the hydrogen-oil mixture in gas-liquid state in the reactor, and obtaining a viscosity-reduced and upgraded oil after the reaction.

In the above-mentioned method for viscosity-reducing and upgrading of low-grade heavy oil, preferably, the cut point of the light distillate oil and the heavy distillate oil is 400 to 565° C.

In the above-mentioned method for viscosity-reducing and upgrading of low-grade heavy oil, more preferably, the cut point of the light distillate oil and the heavy distillate oil is 440 to 540° C.

Preferably, the above method for viscosity-reducing and, upgrading of low-grade heavy oil further comprises: mixing the hydrogenated liquid product obtained by the hydrogenation reaction with the heavy distillate oil to obtain a viscosity-reduced and upgraded oil.

The method for viscosity-reducing and upgrading of low-grade heavy oil provided by the present disclosure adopts the light distillate oil obtained by thermal visbreaking to hydrogenate saturated olefins. As a result, the possible adverse effects of the decarbonization reaction and the demetalization reaction in the heavy distillate oil on the long-period operation of the fixed-bed hydrogenation are avoided.

In the above-mentioned method for viscosity-reducing and upgrading of low-grade heavy oil, preferably, in step (b), the hydrogenation reaction is carried out in a fixed-bed reactor, and the hydrogen-oil mixture enters the fixed-bed reactor from the top or bottom of the fixed-bed reactor.

In the above-mentioned method for viscosity-reducing and upgrading of low-grade heavy oil, more preferably, in step (b), the hydrogenation reaction is carried out in a fixed-bed reactor, and the hydrogen-oil mixture enters the fixed-bed reactor from the bottom of the fixed-bed reactor.

In the above-mentioned method for viscosity-reducing and upgrading of low-grade heavy oil, preferably, in step (b), the hydrogenation reaction process conditions are: a reaction pressure ranging from 1.0 to 20.0 MPa, a reaction temperature ranging from 260 to 450° C., and a liquid hourly volumetric space velocity ranging from 0.1 to 10.0 h⁻¹; and

in the hydrogen-oil mixture in gas-liquid state, the volume ratio of hydrogen to oil is in the range of 20 to 2000.

In the above-mentioned method for viscosity-reducing and upgrading of low-grade heavy oil, more preferably, in step (b), the hydrogenation reaction process conditions are: a reaction pressure ranging from 1.0 to 10.0 MPa, a reaction temperature ranging from 300 to 380° C., and a liquid hourly volumetric space velocity ranging from 0.5 to 6.0 h⁻¹; and

in the hydrogen-oil mixture in gas-liquid state, the volume ratio of hydrogen to oil is in the range of 50 to 1000.

In step (b), the produced oil obtained in step (a) is mixed with hydrogen in a gas-liquid mixer. The mixing process is carried out in the gas-liquid mixer and excess hydrogen is used to dissolve the hydrogen in the produced oil as much as possible to obtain a hydrogen-oil mixture in liquid state. The excess hydrogen can be discharged through the gas-liquid mixer; here, it can be considered that there is no gas phase in the hydrogen-oil mixture in liquid state, that is, there is no volume ratio of hydrogen-oil at this time.

The produced oil obtained in step (a) is mixed with hydrogen (mixed in the pipeline) to obtain a hydrogen-oil mixture in gas-liquid state. At this time, there is a gas phase (hydrogen), and the volume ratio of hydrogen-oil needs to be controlled at 50 to 1000.

In the above-mentioned method for viscosity-reducing and upgrading of low-grade heavy oil, preferably, there are one or more fixed-bed reactors; when there are two fixed-bed reactors, the setting mode and operation steps of the two fixed-bed reactors are either of the following two instances:

the first instance: the two fixed-bed reactors being arranged in parallel, and the inlet pipelines of the two fixed-bed reactors being respectively provided with feed valves;

(S1) closing the feed valve of the second fixed-bed reactor, opening the feed valve of the first fixed-bed reactor, and using the first fixed-bed reactor for hydrogenation reaction;

(S2) when the hydrogenation catalyst in the first fixed-bed reactor is deactivated, opening the feed valve of the second fixed-bed reactor, using the second fixed-bed reactor for hydrogenation reaction, closing the feed valve of the first fixed-bed reactor, and replacing the deactivated hydrogenation catalyst in the first fixed-bed reactor with the regenerated hydrogenation catalyst and/or fresh hydrogenation catalyst;

(S3) when the hydrogenation catalyst in the second fixed-bed reactor is deactivated, opening the feed valve of the first fixed-bed reactor, using the first fixed-bed reactor for hydrogenation reaction, closing the feed valve of the second fixed-bed reactor, and replacing the deactivated hydrogenation catalyst in the second fixed-bed reactor with the regenerated hydrogenation catalyst and/or fresh hydrogenation catalyst;

(S4) repeating steps (S1) to (S3) for hydrogenation reaction;

the second instance: the inlet and outlet pipelines of the two fixed-bed reactors being provided with a feed valve and a discharge valve respectively; a pipeline with a one-way valve being connected before the discharge valve of each fixed-bed reactor, and being connected behind the feed valve of the other fixed-bed reactor, so that materials (hydrogen-oil mixture) can be introduced from the outlet of one fixed-bed reactor to the inlet of the other reactor;

S1) in the initial stage of the reaction, using the two fixed-bed reactors together, the hydrogen-oil mixture first entering the first fixed-bed reactor, and then entering the second fixed-bed reactor through the pipeline with a one-way valve for hydrogenation reaction:

S2) after a period of reaction, when the activity of the hydrogenation catalyst in the first fixed-bed reactor is close to the mid-to-late stage, changing the flow direction of the hydrogen-oil mixture so that the hydrogen-oil mixture first enters the second fixed-bed reactor, and then enters the first fixed-bed reactor through the pipeline with a one-way valve;

S3) when the hydrogenation catalyst in the first fixed-bed reactor is in the deactivation stage, closing the feed valve of the first fixed-bed reactor, and replacing the deactivated hydrogenation catalyst in the first fixed-bed reactor with the regenerated hydrogenation catalyst and/or fresh hydrogenation catalyst, and at this time, the hydrogen-oil mixture only entering the second fixed-bed reactor;

S4) after the catalyst in the first fixed-bed reactor is replaced, the hydrogen-oil mixture first entering the second fixed-bed reactor, and then entering the first fixed-bed reactor where the catalyst has been replaced, through the pipeline with a one-way valve;

S5) when the hydrogenation catalyst in the second fixed-bed reactor is in the deactivation stage, closing the feed valve of the second fixed-bed reactor, and replacing the hydrogenation catalyst in the second fixed-bed reactor with the regenerated hydrogenation catalyst and/or fresh hydrogenation catalyst, and at this time, the hydrogen-oil mixture only entering the first fixed-bed reactor; and

S6) after the catalyst in the second fixed-bed reactor is replaced, repeating steps (S1) to (S5) for hydrogenation reaction.

In the above-mentioned method for viscosity-reducing and upgrading of low-grade heavy oil, preferably, in step (b), the hydrogenation catalyst contains at least one of Mo, Ni, Co, and W, the pore volume of the hydrogenation catalyst is in the range of 0.6-1.8 mL/g, the specific surface area is in the range of 40 to 280 m²/g, and the volume of pores with a pore diameter greater than 50 nm in the hydrogenation catalyst accounts for more than 20% of total pore volume.

In the above-mentioned method for viscosity-reducing and upgrading of low-grade heavy oil, preferably, the pore structure of the hydrogenation catalyst presents a bimodal distribution or a trimodal distribution, and when the pore structure of the hydrogenation catalyst presents a bimodal distribution, the most probable pore diameter of the small pores is 10 to 50 nm, and the most probable pore diameter of the large pores is 50 to 5000 nm;

when the pore structure of the hydrogenation catalyst presents a trimodal distribution, the most probable pore diameters are 10 to 50 nm, 50 to 500 nm, and 500 to 5000 nm, respectively.

In the above-mentioned method for viscosity-reducing and upgrading of low-grade heavy oil, preferably, the hydrogenation catalyst is a sulfided catalyst.

In the above-mentioned method for viscosity-reducing and upgrading of low-grade heavy oil, preferably, in step (b), the viscosity-reduced and upgraded oil has a kinematic viscosity at 20° C. of less than 1200 cSt and an API degree of greater than 14.

In the above-mentioned method for viscosity-reducing and upgrading of low-grade heavy oil, more preferably, in step (b), the viscosity-reduced and upgraded oil has a kinematic viscosity at 20° C. of less than 380 cSt and an API degree of greater than 19.

In another aspect, the present disclosure also provides a device for viscosity-reducing and upgrading of low-grade heavy oil, for carrying out the above-mentioned method for viscosity-reducing and upgrading of low-grade heavy oil, wherein,

when the raw material for the hydrogenation reaction in the method for viscosity-reducing and upgrading of low-grade heavy oil is a hydrogen-oil mixture in gas-liquid state, the device for viscosity-reducing and upgrading of low-grade heavy oil includes: a visbreaking device and a fixed-bed reactor, wherein the liquid outlet is connected to the inlet of the fixed-bed reactor through a pipeline;

when the raw material for the hydrogenation reaction in the method for viscosity-reducing and upgrading of low-grade heavy oil is a hydrogen-oil mixture in liquid state, the device for viscosity-reducing and upgrading of low-grade heavy oil includes: a visbreaking device, a gas-liquid mixer and a fixed-bed reactor, wherein the gas-liquid mixer is provided with at least a gas inlet, a liquid inlet and a liquid outlet; the liquid outlet of the visbreaking device is connected to the liquid inlet of the gas-liquid mixer through a pipeline, and the liquid outlet of the gas-liquid mixer is connected to the inlet of the fixed-bed reactor through a pipeline.

Preferably, the above-mentioned device for viscosity-reducing and upgrading of low-grade heavy oil further comprises a fractionation column; when the raw material for the hydrogenation reaction in the method for viscosity-reducing and upgrading of low-grade heavy oil is a hydrogen-oil mixture in gas-liquid state, the liquid outlet of the visbreaking device is connected to the liquid inlet of the fractionation column through a pipeline, and the light distillate oil outlet of the fractionation column is connected to the inlet of the fixed-bed reactor through a pipeline;

when the raw material for the hydrogenation reaction in the method for viscosity-reducing and upgrading of low-grade heavy oil is a hydrogen-oil mixture in liquid state, the liquid outlet of the visbreaking device is connected to the liquid inlet of the fractionation column through a pipeline, the light distillate oil outlet of the fractionation column is connected to the liquid inlet of the gas-liquid mixer through a pipeline, and the liquid outlet of the gas-liquid mixer is connected to the inlet of the fixed-bed reactor through a pipeline.

Preferably, the above-mentioned device for viscosity-reducing and upgrading of low-grade heavy oil further comprises a storage tank for the viscosity-reduced and upgraded oil, and the heavy distillate oil outlet of the fractionation column and the outlet of the fixed-bed reactor are respectively connected to the storage tank for the viscosity-reduced and upgraded oil through pipelines.

In the above-mentioned device for viscosity-reducing and upgrading of low-grade heavy oil, preferably, there are one or more fixed-bed reactors; and when there are two fixed-bed reactors, the two fixed-bed reactors are arranged in parallel, each of the inlet pipelines of the two fixed-bed reactors is provided with a feed valve.

In the above-mentioned device for viscosity-reducing and upgrading of low-grade heavy oil, preferably, there are one or more fixed-bed reactor; and when there are two fixed-bed reactors, the inlet and outlet pipelines of the two fixed-bed reactors are respectively provided with a feed valve and a discharge valve; a pipeline with a one-way valve is connected before the discharge valve of each fixed-bed reactor, and is connected behind the feed valve of the other fixed-bed reactor, so that materials (hydrogen-oil mixture) can be introduced from the outlet of one fixed-bed reactor to the inlet of the other reactor.

In the present disclosure, the term “before” in the phrase “before the discharge valve” refers to the position between the discharge valve and the fixed-bed reactor: the term “behind” in the phrase “behind the feed valve” refers to the position between the feed valve and the fixed-bed reactor. The position between the fixed-bed reactors.

In the present disclosure, the fixed-bed reactor, fractionation column, gas-liquid mixer and other equipment used are all conventional equipment in the field.

As compared to the prior art, the method for viscosity-reducing and upgrading of low-grade heavy oil provided by the present disclosure has the following advantages:

The method adopts a combined process of thermal visbreaking and fixed-bed hydrogenation, wherein thermal visbreaking can minimize the viscosity of low-grade heavy oil, improve fluidity, reduce density, and increase API. Fixed-bed hydrogenation can saturate the olefins produced by thermal visbreaking and improve the stability of oil products. In particular, as compared to the conventional residual fixed-bed hydrorefining process, the present disclosure adopts more gentle hydrogenation reaction process conditions and effectively saturates olefins while reducing the decarbonization reaction and the demetalization reaction. In particular, the present disclosure uses catalysts having more macroporous structures, and/or adopts a switchable dual-reactor process, to further improve and/or guarantee the operation period of the fixed-bed hydrogenation process.

The beneficial effects of the present disclosure lie in:

The method of the present disclosure can effectively transform low-grade heavy oil into a heavy oil having a kinematic viscosity (20° C.) of less than 1200 cSt and an API degree of greater than 14, especially a kinematic viscosity (20° C.) of less than 380 cSt, an API degree of greater than 19, and having good stability. It can meet the requirements of pipeline transportation and storage, has low investment and simple operation, and it suitable for industrial production.

### BRIEF DESCRIPTION OF DRAWINGS

In order to explain the embodiments of the present disclosure or the technical solutions in the prior art more clearly, the drawings needed in the description of the embodiments will be briefly introduced below. Obviously, the drawings in the following description are some examples of the present disclosure. For those of ordinary skill in the art, other drawings can be obtained based on these drawings without creative work.

FIG. 1 is a structural schematic diagram of a device for viscosity-reducing and upgrading of low-grade heavy oil as provided in Example 1 of the present disclosure.

FIG. 2 is a structural schematic diagram of a device for viscosity-reducing and upgrading of low-grade heavy oil as provided in Example 2 of the present disclosure.

FIG. 3 is a structural schematic diagram of a device for viscosity-reducing and upgrading of low-grade heavy oil as provided in Example 3 of the present disclosure.

FIG. 4 is a structural schematic diagram of a device for viscosity-reducing and upgrading of low-grade heavy oil as provided in Example 4 of the present disclosure.

FIG. 5 is a structural schematic diagram of a device for viscosity-reducing and upgrading of low-grade heavy oil as provided in Example 5 of the present disclosure.

FIG. 6 is a structural schematic diagram of a device for viscosity-reducing and upgrading of low-grade heavy oil as provided in Example 6 of the present disclosure.

FIG. 7 is a structural schematic diagram of a device for viscosity-reducing and upgrading of low-grade heavy oil as provided in Example 7 of the present disclosure.

FIG. 8 is a structural schematic diagram of a device for viscosity-reducing and upgrading of low-grade heavy oil as provided in Example 8 of the present disclosure.

FIG. 9 is a structural schematic diagram of a device for viscosity-reducing and upgrading of low-grade heavy oil as provided in Example 9 of the present disclosure.

FIG. 10 is a structural schematic diagram of a device for viscosity-reducing and upgrading of low-grade heavy oil as provided in Example 10 of the present disclosure.

FIG. 11 is a structural schematic diagram of a device for viscosity-reducing and upgrading of low-grade heavy oil as provided in Example 11 of the present disclosure.

FIG. 12 is a structural schematic diagram of a device for viscosity-reducing and upgrading of low-grade heavy oil as provided in Example 12 of the present disclosure.

### DESCRIPTION OF MAIN REFERENCE SIGNS

1. visbreaking device;
2. gas-liquid mixer;
3. fixed-bed reactor;
31. first fixed-bed reactor;
32. second fixed-bed reactor;
4. fractionation column;
5. storage tank for the viscosity-reduced and upgraded oil.

### DESCRIPTION OF EMBODIMENTS

In order to have a clearer understanding of the technical features, objectives and beneficial effects of the present disclosure, the technical solutions of the present disclosure are described in detail below in conjunction with the following specific examples, but they cannot be understood as limiting the scopes of the present disclosure.

### Example 1

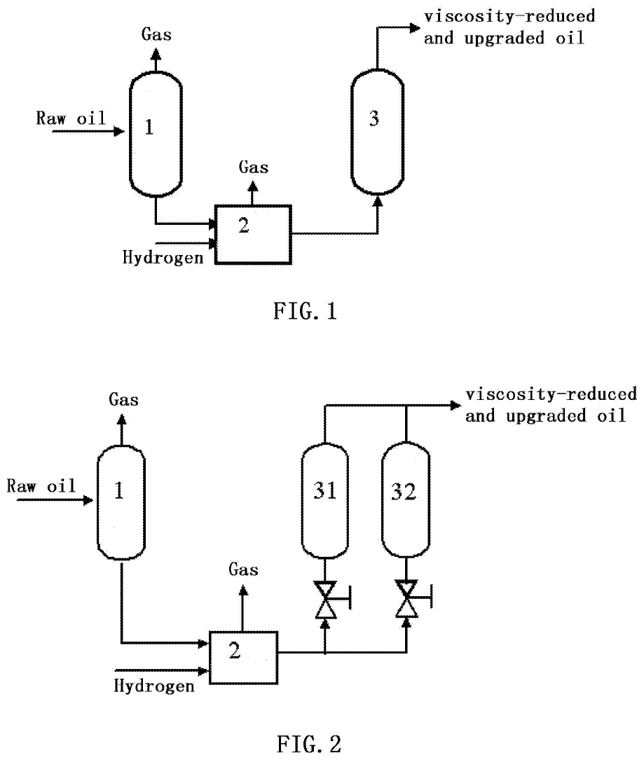

This example provides a device for viscosity-reducing and upgrading of low-grade heavy oil, of which the structural schematic diagram is shown in FIG. 1. As can be seen from FIG. 1, the device includes: a visbreaking device 1; a gas-liquid mixer 2; and a fixed-bed reactor 3. The gas-liquid mixer 2 is provided with at least a gas inlet, a liquid inlet and a liquid outlet. The liquid outlet of the visbreaking device 1 is connected to the liquid inlet of the gas-liquid mixer 2 through a pipeline, and the liquid outlet of the gas-liquid mixer 2 is connected to the inlet of the fixed-bed reactor 3 through a pipeline.

### Example 2

This example provides a device for viscosity-reducing and upgrading of low-grade heavy oil, of which the structural schematic diagram is shown in FIG. 2. As can be seen from FIG. 2, the device includes: a visbreaking device 1; a gas-liquid mixer 2; and two fixed-bed reactors, a first fixed-bed reactor 31 and a second fixed-bed reactor 32, which are arranged in parallel. The gas-liquid mixer 2 is provided with at least a gas inlet, a liquid inlet, and a liquid outlet. The liquid outlet of the visbreaking device 1 is connected to the liquid inlet of the gas-liquid mixer 2 through a pipeline, and the liquid outlet of the gas-liquid mixer 2 is connected to the inlets of the first fixed-bed reactor 31 and the second fixed-bed reactor 32 through a first feed valve and a second feed valve respectively through pipelines.

### Example 3

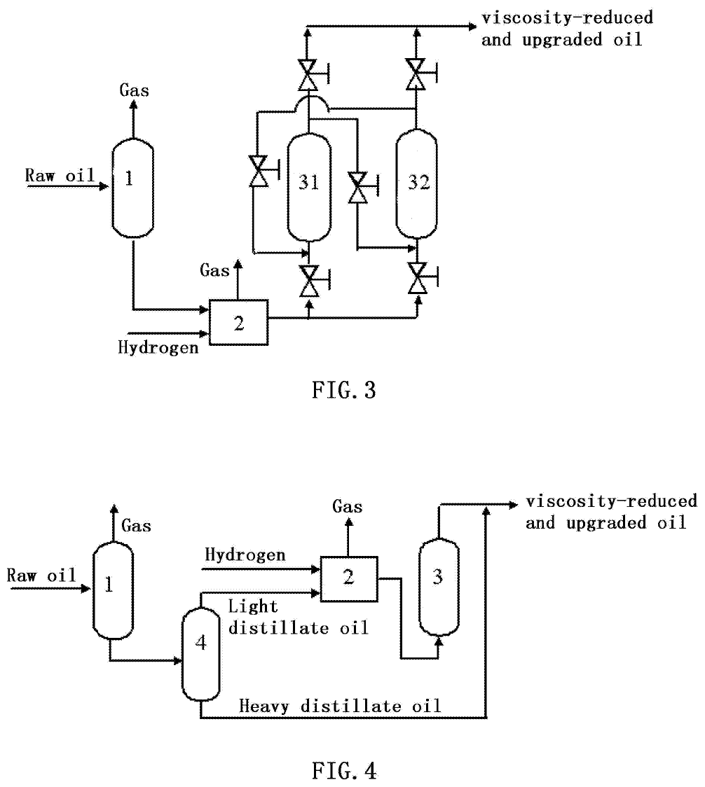

This example provides a device for viscosity-reducing and upgrading of low-grade heavy oil, of which the structural schematic diagram is shown in FIG. 3. As can be seen from FIG. 3, the device includes: a visbreaking device 1; a gas-liquid mixer 2; and two fixed-bed reactors, a first fixed-bed reactor 31 and a second fixed-bed reactor 32. The gas-liquid mixer 2 is provided with at least a gas inlet, a liquid inlet, and a liquid outlet. The liquid outlet of the visbreaking device 1 is connected to the liquid inlet of the gas-liquid mixer 2 through a pipeline, and the liquid outlet of the gas-liquid mixer 2 is connected to the inlets of the first fixed-bed reactor 31 and the second fixed-bed reactor 32 via a first feed valve and a second feed valve respectively through pipelines.

The outlet pipes of the first fixed-bed reactor 31 and the second fixed-bed reactor 32 are provided with a first discharge valve and a second discharge valve respectively.

A pipeline with a first one-way valve and a pipeline with a second one-way valve are connected before the discharge valves of the first fixed-bed reactor 31 and the second fixed-bed reactor 32 respectively, and are connected behind the feed valves of the second fixed-bed reactor 32 and the first fixed-bed reactor 31 respectively in the back, so that materials can be introduced from the outlet of one fixed-bed reactor to the inlet of the other reactor.

### Example 4

This example provides a device for viscosity-reducing and upgrading of low-grade heavy oil, of which the structural schematic diagram is shown in FIG. 4. As can be seen from FIG. 4, the device includes: a visbreaking device 1; a gas-liquid mixer 2; a fixed-bed reactor 3; and a fractionation column 4. The gas-liquid mixer 2 is provided with at least a gas inlet, a liquid inlet and a liquid outlet. The liquid outlet of the visbreaking device 1 is connected to the liquid inlet of the fractionation column 4 through a pipeline. The light distillate oil outlet of the fractionation column 4 is connected to the liquid inlet of the gas-liquid mixer 2 through a pipeline, and the liquid outlet of the gas-liquid mixer 2 is connected to the inlet of the fixed-bed reactor 3 through a pipeline.

In this example, the device further comprises a storage tank for the viscosity-reduced and upgraded oil (not shown in the figure), and the heavy distillate oil outlet of the fractionation column 4 and the outlet of the fixed-bed reactor 3 are respectively connected to the storage tank for the viscosity-reduced and upgraded oil through pipelines.

### Example 5

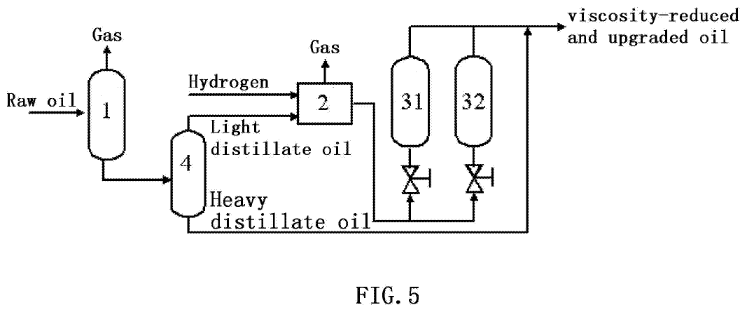

This example provides a device for viscosity-reducing and upgrading of low-grade heavy oil, of which the structural schematic diagram is shown in FIG. 5. As can be seen from FIG. 5, the device includes: a visbreaking device 1; a gas-liquid mixer 2; two fixed-bed reactors, a first fixed-bed reactor 31 and a second fixed-bed reactor 32, which are arranged in parallel; and a fractionation column 4. The gas-liquid mixer 2 is provided with at least a gas inlet, a liquid inlet and a liquid outlet. The liquid outlet of the visbreaking device 1 is connected to the liquid inlet of the fractionation column 4 through a pipeline. The light distillate oil outlet of the fractionation column 4 is connected to the liquid inlet of the gas-liquid mixer 2 through a pipeline, and the liquid outlet of the gas-liquid mixer 2 is connected to the inlets of the first fixed-bed reactor 31 and the second fixed-bed reactor 32 via a first feed valve and a second feed valve respectively through pipelines.

In this example, the device further comprises a storage tank for the viscosity-reduced and upgraded oil (not shown in the figure), and the heavy distillate oil outlet of the fractionation column 4 and the outlets of the first fixed-bed reactor 31 and the second fixed-bed reactor 32 are respectively connected to the storage tank for the viscosity-reduced and upgraded oil through pipelines.

### Example 6

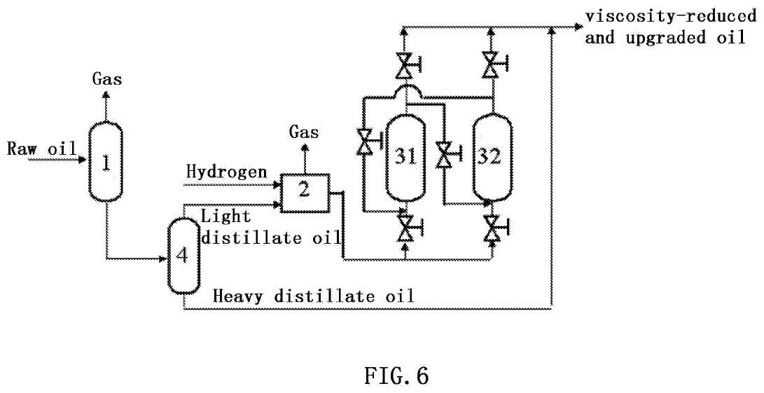

This example provides a device for viscosity-reducing and upgrading of low-grade heavy oil. of which the structural schematic diagram is shown in FIG. 6. As can be seen from FIG. 6, the device includes: a visbreaking device 1; a gas-liquid mixer 2; two fixed-bed reactors, a first fixed-bed reactor 31 and a second fixed-bed reactor 32; and a fractionation column 4. The gas-liquid mixer 2 is provided with at least a gas inlet, a liquid inlet and a liquid outlet. The liquid outlet of the visbreaking device 1 is connected to the liquid inlet of the fractionation column 4 through a pipeline. The light distillate oil outlet of the fractionation column 4 is connected to the liquid inlet of the gas-liquid mixer 2 through a pipeline, and the liquid outlet of the gas-liquid mixer 2 is connected to the inlets of the first fixed-bed reactor 31 and the second fixed-bed reactor 32 via a first feed valve and a second feed valve respectively through pipelines.

The outlet pipes of the first fixed-bed reactor 31 and the second fixed-bed reactor 32 are provided with a first discharge valve and a second discharge valve respectively.

A pipeline with a first one-way valve and a pipeline with a second one-way valve are connected before the discharge valves of the first fixed-bed reactor 31 and the second fixed-bed reactor 32 respectively, and are connected behind the feed valves of the second fixed-bed reactor 32 and the first fixed-bed reactor 31 respectively in the back, so that materials can be introduced from the outlet of one fixed-bed reactor to the inlet of the other reactor.

In this example, the device further comprises a storage tank for the viscosity-reduced and upgraded oil (not shown in the figure), and the heavy distillate oil outlet of the fractionation column 4 and the outlets of the first fixed-bed reactor 31 and the second fixed-bed reactor 32 are respectively connected to the storage tank for the viscosity-reduced and upgraded oil through pipelines.

### Example 7

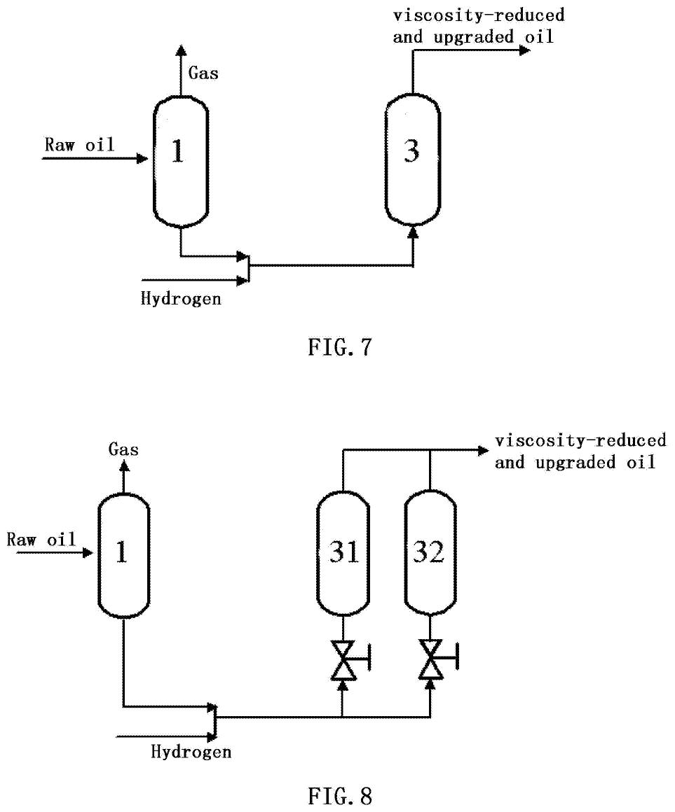

This example provides a device for viscosity-reducing and upgrading of low-grade heavy oil, of which the structural schematic diagram is shown in FIG. 7. As can be seen from FIG. 7, the device includes: a visbreaking device 1; and a fixed-bed reactor 3. The liquid outlet of the visbreaking device 1 is connected to the liquid inlet of the fixed-bed reactor 3 through a pipeline, and the outlet of the hydrogen storage tank is also connected to the liquid inlet of the fixed-bed reactor 3 through a pipeline.

### Example 8

This example provides a device for viscosity-reducing and upgrading of low-grade heavy oil, of which the structural schematic diagram is shown in FIG. 8. As can be seen from FIG. 8, the device includes: a visbreaking device 1; and two fixed-bed reactors, a first fixed-bed reactor 31 and a second fixed-bed reactor 32, which are arranged in parallel. The liquid outlet of the visbreaking device 1 is connected to the inlets of the first fixed-bed reactor 31 and the second fixed-bed reactor 32 via a first feed valve and a second feed valve respectively through pipelines.

### Example 9

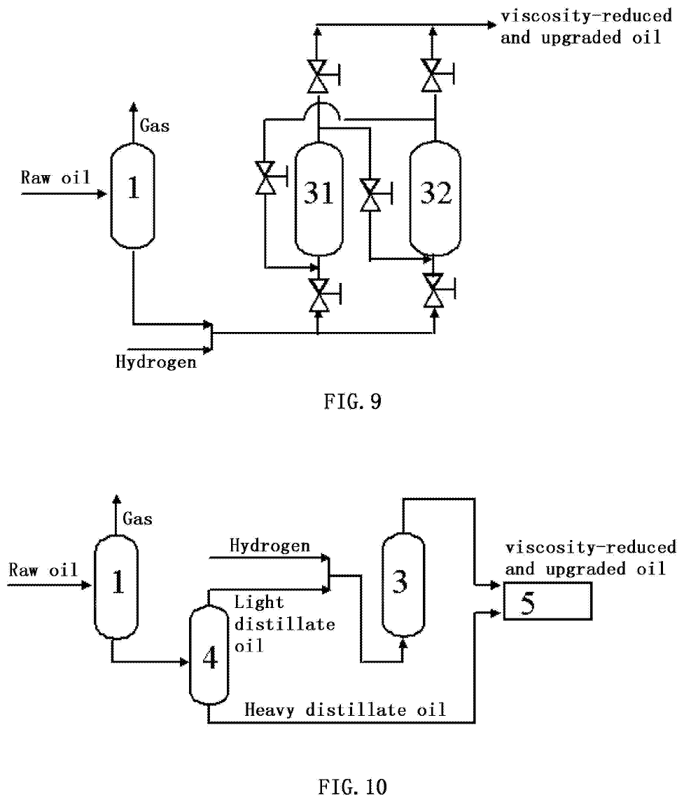

This example provides a device for viscosity-reducing and upgrading of low-grade heavy oil, of which the structural schematic diagram is shown in FIG. 9. As can be seen from FIG. 9, the device includes: a visbreaking device 1; and two fixed-bed reactors, a first fixed-bed reactor 31 and a second fixed-bed reactor 32. The liquid outlet of the visbreaking device 1 is connected to the inlets of the first fixed-bed reactor 31 and the second fixed-bed reactor 32 via a first feed valve and a second feed valve respectively through pipelines.

The outlet pipes of the first fixed-bed reactor 31 and the second fixed-bed reactor 32 are provided with a first discharge valve and a second discharge valve respectively.

A pipeline with a first one-way valve and a pipeline with a second one-way valve are connected before the discharge valves of the first fixed-bed reactor 31 and the second fixed-bed reactor 32 respectively, and are connected behind the feed valves of the second fixed-bed reactor 32 and the first fixed-bed reactor 31 respectively in the back, so that materials can be introduced from the outlet of one fixed-bed reactor to the inlet of the other reactor.

### Example 10

This example provides a device for viscosity-reducing and upgrading of low-grade heavy oil, of which the structural schematic diagram is shown in FIG. 10. As can be seen from FIG. 10, the device includes: a visbreaking device 1; a fixed-bed reactor 3; and a fractionation column 4. The liquid outlet of the visbreaking device 1 is connected to the liquid inlet of the fractionation column 4 through a pipeline. The light distillate oil outlet of the fractionation column 4 is connected to the inlet of the fixed-bed reactor 3 through a pipeline, and the outlet of the hydrogen storage tank is also connected to the inlet of the fixed-bed reactor 3 through a pipeline.

In this example, the device further comprises a storage tank for the viscosity-reduced and upgraded oil 5, and the heavy distillate oil outlet of the fractionation column 4 and the outlet of the fixed-bed reactor 3 are respectively connected to the storage tank for the viscosity-reduced and upgraded oil 5 through pipelines.

### Example 11

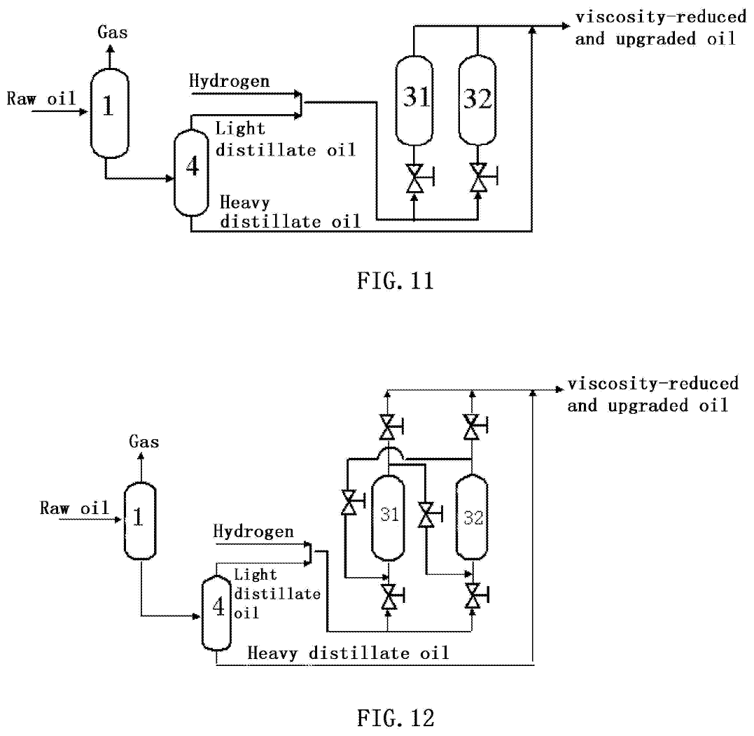

This example provides a device for viscosity-reducing and upgrading of low-grade heavy oil, of which the structural schematic diagram is shown in FIG. 11. As can be seen from FIG. 11, the device includes: a visbreaking device 1; two fixed-bed reactors, a first fixed-bed reactor 31 and a second fixed-bed reactor 32, which are arranged in parallel; and a fractionation column 4; the liquid outlet of the visbreaking device 1 is connected to the liquid inlet of the fractionation column 4 through a pipeline. The light distillate oil outlet of the fractionation column 4 is connected to the inlets of the first fixed-bed reactor 31 and the second fixed-bed reactor 32 via a first feed valve and a second feed valve respectively through pipelines.

In this example, the device further comprises a storage tank for the viscosity-reduced and upgraded oil (not shown in the figure), and the heavy distillate oil outlet of the fractionation column 4 and the outlets of the first fixed-bed reactor 31 and the second fixed-bed reactor 32 are respectively connected to the storage tank for the viscosity-reduced and upgraded oil through pipelines.

### Example 12

This example provides a device for viscosity-reducing and upgrading of low-grade heavy oil, of which the structural schematic diagram is shown in FIG. 12. As can be seen from FIG. 12, the device includes: a visbreaking device 1; two fixed-bed reactors, a first fixed-bed reactor 31 and a second fixed-bed reactor 32; and a fractionation column 4. The liquid outlet of the visbreaking device 1 is connected to the liquid inlet of the fractionation column 4 through a pipeline. The light distillate oil outlet of the fractionation column 4 is connected to the inlets of the first fixed-bed reactor 31 and the second fixed-bed reactor 32 via a first feed valve and a second feed valve respectively through pipelines.

The outlet pipes of the first fixed-bed reactor 31 and the second fixed-bed reactor 32 are provided with a first discharge valve and a second discharge valve respectively.

A pipeline with a first one-way valve and a pipeline with a second one-way valve are connected before the discharge valves of the first fixed-bed reactor 31 and the second fixed-bed reactor 32 respectively, and are connected behind the feed valves of the second fixed-bed reactor 32 and the first fixed-bed reactor 31 respectively in the back, so that materials can be introduced from the outlet of one fixed-bed reactor to the inlet of the other reactor.

In this example, the device further comprises a storage tank for the viscosity-reduced and upgraded oil (not shown in the figure), and the heavy distillate oil outlet of the fractionation column 4 and the outlets of the first fixed-bed reactor 31 and the second fixed-bed reactor 32 are respectively connected to the storage tank for the viscosity-reduced and upgraded oil through pipelines.

### Example 13

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 1, and the method includes the following steps:

In this example, the low-grade heavy oil is oil sand bitumen with a kinematic viscosity (80° C.) of 8520 cSt and an API degree of 8.3. Its properties are shown in Table 1 below.

As shown in FIG. 1, the oil sand bitumen enters the visbreaking device for visbreaking reaction. The operating process conditions are: a reaction temperature of 415° C., a reaction pressure of 0.6 MPa, a residence time of 5 minutes, a mass conversion rate of visbreaking reaction of 20%, and the mass content of toluene insolubles in the produced oil of 0.05%.

The produced oil and hydrogen are mixed in a gas-liquid mixer to form a hydrogen-oil mixture in liquid state. The hydrogen-oil mixture enters a fixed-bed reactor filled with a hydrogenation catalyst for hydrogenation. The hydrogenation catalyst contains Ni and Mo. The hydrogenation catalyst has a pore volume of 1.0 mL/g and a specific surface area of 160 m²/g, and the volume of pores with a pore diameter greater than 50 nm in the hydrogenation catalyst accounts for 32% of the total pore volume. The pores of the hydrogenation catalyst present a bimodal distribution. The most probable pore diameter of the small pores is 20 nm, and the most probable pore diameter of the large pores is 800 nm. The hydrogenation catalyst is a sulfided catalyst. The process conditions of fixed-bed hydrogenation reaction are: a reaction pressure of 4.0 MPa; a reaction temperature of 320° C.; and a liquid hourly volumetric space velocity of 4.0 h⁻¹. After the hydrogenation reaction is completed, a viscosity-reduced and upgraded oil with a kinematic viscosity (20° C.) of 324 cSt and an API degree of 19.5 is obtained. The properties of the viscosity-reduced and upgraded oil are shown in Table 1.

Table 1

TABLE 1

| | Example 13 | |
|---|---|---|
| | Raw material | Product |
| Kinematic viscosity, cSt | 8520 (80° C.) | 324 (20° C.) |
| API degree | 8.3 | 19.5 |
| Olefin, % | — | 0.02 |
| CCR, % | 17.8 | 18.0 |
| Ni, μg/g | 95.5 | 78.6 |
| V, μg/g | 255.6 | 211.9 |

| | | |
|---|---|---|
| Visbreaking | Reaction temperature, ° C. | 415 |
| | Reaction pressure, MPa | 0.6 |
| | Residence time, min | 5 |
| Fixed-bed | Reaction pressure, MPa | 4.0 |
| hydrogena- | Reaction temperature, ° C. | 320 |
| tion | Liquid hourly volumetric | 4.0 |
| | space velocity, h⁻¹ | |

### Example 14

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 2, and the method includes the following steps:

In this example, the low-grade heavy oil is heavy oil with a kinematic viscosity (80° C.) of 7668 cSt and an API degree of 8.1. Its properties are shown in Table 2 below.

As shown in FIG. 2, the heavy oil enters the visbreaking device for visbreaking reaction. The operating process conditions are: a reaction temperature of 435° C., a reaction pressure of 0.6 MPa, a residence time of 10 minutes, a mass conversion rate of visbreaking reaction of 40%, and the mass content of toluene insolubles in the produced oil of 0.03%.

The produced oil and hydrogen are mixed in a gas-liquid mixer to form a hydrogen-oil mixture in liquid state. The hydrogen-oil mixture enters a fixed-bed reactor filled with a hydrogenation catalyst for hydrogenation. The hydrogenation catalyst contains Co and Mo. The hydrogenation catalyst has a pore volume of 1.2 mL/g and a specific surface area of 132 m²/g, and the volume of pores with a pore diameter greater than 50 mu in the hydrogenation catalyst accounts for 44% of the total pore volume. The pores of the hydrogenation catalyst present a trimodal distribution. The most probable pore diameters are 24 nm, 280 nm, 1160 nm, respectively. The hydrogenation catalyst is a sulfided catalyst. The process conditions of fixed-bed hydrogenation reaction are: a reaction pressure of 8.0 MPa, a reaction temperature of 360° C., and a liquid hourly volumetric space velocity of 2.0 h⁻¹. After the hydrogenation reaction is completed, a viscosity-reduced and upgraded oil with a kinematic viscosity (20° C.) of 66 cSt and an API degree of 19.6 is obtained. The properties of the viscosity-reduced and upgraded oil are shown in Table 2.

In this example, the operation steps of the fixed-bed reactors are as follows:

(S1) closing the feed valve of the second fixed-bed reactor, opening the feed valve of the first fixed-bed reactor, and using the first fixed-bed reactor for hydrogenation reaction;

(S2) when the hydrogenation catalyst in the first fixed-bed reactor is deactivated, opening the feed valve of the second fixed-bed reactor, using the second fixed-bed reactor for hydrogenation reaction, closing the feed valve of the first fixed-bed reactor, and replacing the deactivated hydrogenation catalyst in the first fixed-bed reactor with the regenerated hydrogenation catalyst and/or fresh hydrogenation catalyst;

(S3) when the hydrogenation catalyst in the second fixed-bed reactor is deactivated, opening the feed valve of the first fixed-bed reactor, using the first fixed-bed reactor for hydrogenation reaction, closing the feed valve of the second fixed-bed reactor, and replacing the hydrogenation catalyst in the second fixed-bed reactor with the regenerated hydrogenation catalyst and/or fresh hydrogenation catalyst;

(S4) repeating steps (S1) to (S3) for hydrogenation reaction.

TABLE 2

| | Example 14 | |
|---|---|---|
| | Raw material | Product |
| Kinematic viscosity, cSt | 7668 (80° C.) | 66 (20° C.) |
| API degree | 8.1 | 19.6 |
| Olefin, % | — | 0.01 |
| CCR, % | 16.7 | 16.8 |
| Ni, μg/g | 76.0 | 64.9 |
| V, μg/g | 482.3 | 430.6 |

| Visbreaking | Reaction | 435 |
|---|---|---|
| | temperature, ° C. | |
| | Reaction pressure, MPa | 0.6 |
| | Residence time, min | 10 |
| fixed-bed | Reaction pressure, MPa | 8.0 |
| hydrogenation | Reaction | 360 |
| | temperature, ° C. | |
| | Liquid hourly | 2.0 |
| | volumetric space | |
| | velocity, h⁻¹ | |

### Example 15

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 3, and the method includes the following steps:

In this example, the low-grade heavy oil is vacuum residuum with a kinematic viscosity (80° C.) of 4457 cSt and an API degree of 7.8. Its properties are shown in Table 3 below.

As shown in FIG. 3, the vacuum residuum enters the visbreaking device for visbreaking reaction. The operating process conditions are: a reaction temperature of 420° C., a reaction pressure of 0.8114 Pa, a residence time of 20 minutes, a mass conversion rate of visbreaking reaction of 30%, and the mass content of toluene insolubles in the produced oil of 0.02%;

The produced oil and hydrogen are mixed in a gas-liquid mixer to form a hydrogen-oil mixture in liquid state. The hydrogen-oil mixture enters a fixed-bed reactor filled with a hydrogenation catalyst for hydrogenation. The hydrogenation catalyst contains Co and W. The hydrogenation catalyst has a pore volume of 1.1 mL/g and a specific surface area of 151 m²/g, and the volume of pores with a pore diameter greater than 50 nm in the hydrogenation catalyst accounts for 38% of the total pore volume. The pores of the hydrogenation catalyst present a bimodal distribution. The most probable pore diameter of the small pores is 30 nm, and the most probable pore diameter of the large pores is 1086 nm. The hydrogenation catalyst is a sulfided catalyst. The process conditions of fixed-bed hydrogenation reaction are: a reaction pressure of 6.0 MPa, a reaction temperature of 340° C., and a liquid hourly volumetric space velocity of 6.0 h⁻¹. After the hydrogenation reaction is completed, a viscosity-reduced and upgraded oil with a kinematic viscosity (20° C.) of 158 cSt and an API degree of 19.3 is obtained. The properties of the viscosity-reduced and upgraded oil are shown in Table 3.

In this example, the operation steps of the fixed-bed reactor are as follows:

S1) in the initial stage of the reaction, using the two fixed-bed reactors together, the hydrogen-oil mixture first entering one of the fixed-bed reactors (such as the first fixed-bed reactor), and then entering the other fixed-bed reactor (such as the second fixed-bed reactor) through the pipeline with a one-way valve for hydrogenation reaction;

S2) after a period of reaction, when the activity of the hydrogenation catalyst in the first fixed-bed reactor is close to the mid-to-late stage, changing the flow direction of the hydrogen-oil mixture so that the hydrogen-oil mixture first enters the second fixed-bed reactor, and then enters the first fixed-bed reactor through the pipeline with a one-way valve;

S3) when the hydrogenation catalyst in the first fixed-bed reactor is in the deactivation stage, closing the feed valve of the first fixed-bed reactor, and replacing the deactivated hydrogenation catalyst in the first fixed-bed reactor with the regenerated hydrogenation catalyst and/or fresh hydrogenation catalyst, and at this time, the hydrogen-oil mixture only entering the second fixed-bed reactor;

S4) after the catalyst in the first fixed-bed reactor is replaced, the hydrogen-oil mixture first entering the second fixed-bed reactor, and then entering the first fixed-bed reactor where the catalyst has been replaced, through the pipeline with a one-way valve;

S5) when the hydrogenation catalyst in the second fixed-bed reactor is in the deactivation stage, closing the feed valve of the second fixed-bed reactor, and replacing the deactivated hydrogenation catalyst in the second fixed-bed reactor with the regenerated hydrogenation catalyst and/or fresh hydrogenation catalyst, and at this time, the hydrogen-oil mixture only entering the first fixed-bed reactor; and

S6) after the catalyst in the second fixed-bed reactor is replaced, repeating steps (S1) to (S5) for hydrogenation reaction.

TABLE 3

| | Example 15 | |
|---|---|---|
| | Raw material | Product |
| Kinematic viscosity, cSt | 4457 (80° C.) | 158 (20° C.) |
| API degree | 7.8 | 19.3 |
| Olefin, % | — | 0.01 |
| CCR, % | 19.2 | 19.2 |
| Ni, μg/g | 88.6 | 66.1 |
| V, μg/g | 182.4 | 153.7 |

| | | |
|---|---|---|
| Visbreaking | Reaction | 420 |
| | temperature, ° C. | |
| | Reaction pressure, MPa | 0.8 |
| | Residence time, min | 20 |
| fixed-bed | Reaction pressure, MPa | 6.0 |
| hydrogenation | Reaction | 340 |
| | temperature, ° C. | |
| | Liquid hourly | 6.0 |
| | volumetric space | |
| | velocity, h⁻¹ | |

### Example 16

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 4, and the method includes the following steps:

In this example, the low-grade heavy oil is oil sand bitumen with a kinematic viscosity (80° C.) of 8510 cSt and an API degree of 8.4;

As shown in FIG. 4, the oil sand bitumen enters the visbreaking device for visbreaking reaction. The operating process conditions are: a reaction temperature of 414° C., a reaction pressure of 0.6 MPa, a residence time of 4.5 minutes, a mass conversion rate of visbreaking reaction of 18%, and the mass content of toluene insolubles in the produced oil of 0.04%.

The produced oil is cut at 500° C. in a fractionation column to obtain a light distillate oil and a heavy distillate oil. The light distillate oil and hydrogen are mixed in a gas-liquid mixer to form a hydrogen-oil mixture in liquid state, and the hydrogen-oil mixture enters a fixed-bed reactor filled with a hydrogenation catalyst for hydrogenation reaction. The hydrogenation catalyst contains Ni and Mo. The hydrogenation catalyst contains Ni and Mo. The hydrogenation catalyst has a pore volume of 1.05 mL/g and a specific surface area of 162 m²/g, and the volume of pores with a pore diameter greater than 50 nm in the hydrogenation catalyst accounts for 30% of the total pore volume. The pores of the hydrogenation catalyst present a bimodal distribution. The most probable pore diameter of the small pores is 22 nm, and the most probable pore diameter of the large pores is 750 nm. The hydrogenation catalyst is a sulfided catalyst. The process conditions of fixed-bed hydrogenation reaction are: a reaction pressure of 4.2 MPa, a reaction temperature of 325° C., and a liquid hourly volumetric space velocity of 4.3 h⁻¹. After the hydrogenation reaction, a hydrogenated liquid product is obtained. The hydrogenated liquid product is then mixed with the heavy distillate oil, to obtain a viscosity-reduced and upgraded oil with a kinematic viscosity (20° C.) of 320 cSt and an API degree of 19.6.

### Example 17

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 5, and the method includes the following steps:

In this example, the low-grade heavy oil is heavy oil with a kinematic viscosity (80° C.) of 7638 cSt and an API degree of 8.2.

As shown in FIG. 5, the heavy oil enters the visbreaking device for visbreaking reaction. The operating process conditions are: a reaction temperature of 436° C., a reaction pressure of 0.6 MPa, a residence time of 9 minutes, a mass conversion rate of visbreaking reaction of 40%, and the mass content of toluene insolubles in the produced oil of 0.03%.

The produced oil is cut at 480° C. in a fractionation column to obtain a light distillate oil and a heavy distillate oil. The light distillate oil and hydrogen are mixed in a gas-liquid mixer to form a hydrogen-oil mixture in liquid state. The hydrogenation catalyst contains Co and Mo. The hydrogenation catalyst has a pore volume of 1.1 mL/g and a specific surface area of 146 m²/g, and the volume of pores with a pore diameter greater than 50 nm in the hydrogenation catalyst accounts for 43% of the total pore volume. The pores of the hydrogenation catalyst are distributed in a trimodal pattern. The most probable pore diameters are 25 nm, 290 nm, 1245 nm, respectively. The hydrogenation catalyst is a sulfided catalyst. The process conditions of fixed-bed hydrogenation reaction are: a reaction pressure of 8.2 MPa, a reaction temperature of 358° C., and liquid hourly volumetric space velocity of 2.2 h⁻¹. After the hydrogenation reaction, a hydrogenated liquid product is obtained. The hydrogenated liquid product is then mixed with the heavy distillate oil, to obtain a viscosity-reduced and upgraded oil with a kinematic viscosity (20° C.) of 64 cSt and an API degree of 19.5.

In this example, the operation steps of the fixed-bed reactor are as follows:

(S1) closing the feed valve of the second fixed-bed reactor, opening the feed valve of the first fixed-bed reactor, and using the first fixed-bed reactor for hydrogenation reaction;

(S2) when the hydrogenation catalyst in the first fixed-bed reactor is deactivated, opening the feed valve of the second fixed-bed reactor, using the second fixed-bed reactor for hydrogenation reaction, closing the feed valve of the first fixed-bed reactor, and replacing the deactivated hydrogenation catalyst in the first fixed-bed reactor with the regenerated hydrogenation catalyst and/or fresh hydrogenation catalyst;

(S3) when the hydrogenation catalyst in the second fixed-bed reactor is deactivated, opening the feed valve of the first fixed-bed reactor, using the first fixed-bed reactor for hydrogenation reaction, closing the feed valve of the second fixed-bed reactor, and replacing the hydrogenation catalyst in the second fixed-bed reactor with the regenerated hydrogenation catalyst and/or fresh hydrogenation catalyst;

(S4) repeating steps (S1) to (S3) for hydrogenation reaction.

### Example 18

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 6, and the method includes the following steps:

In this example, the low-grade heavy oil is vacuum residuum with a kinematic viscosity (80° C.) of 5455 cSt and an API degree of 7.7.

As shown in FIG. 6, the vacuum residuum enters the visbreaking device for visbreaking reaction. The operating process conditions are: a reaction temperature of 418° C., a reaction pressure of 0.8 MPa, a residence time of 23 minutes, a mass conversion rate of visbreaking reaction of 31%, and the mass content of toluene insolubles in the produced oil of 0.03%.

The produced oil is cut at 520° C. in a fractionation column to obtain a light distillate oil and a heavy distillate oil. The light distillate oil and hydrogen are mixed in a gas-liquid mixer to form a hydrogen-oil mixture in liquid state. The hydrogenation catalyst contains Co and W. The hydrogenation catalyst contains Co and W. The hydrogenation catalyst has a pore volume of 1.2 mL/g and a specific surface area of 139 m²/g, and the volume of pores with a pore diameter greater than 50 nm in the hydrogenation catalyst accounts for 35% of the total pore volume. The pores of the hydrogenation catalyst present a bimodal distribution. The most probable pore diameter of the small pores is 33 nm, and the most probable pore diameter of the large pores is 1368 nm. The hydrogenation catalyst is a sulfided catalyst. The process conditions of fixed-bed hydrogenation reaction are: a reaction pressure of 6.6 MPa, a reaction temperature of 344° C., and a liquid hourly volumetric space velocity of 6.7 h⁻¹. After the hydrogenation reaction, a hydrogenated liquid product is obtained. The hydrogenated liquid product is then mixed with the heavy distillate oil, to obtain a viscosity-reduced and upgraded oil with a kinematic viscosity (20° C.) of 167 cSt and an API degree of 19.2.

In this example, the operation steps of the fixed-bed reactor are as follows:

S1) in the initial stage of the reaction, using the two fixed-bed reactors together, the hydrogen-oil mixture first entering one of the fixed-bed reactors (such as the first fixed-bed reactor), and then entering the other fixed-bed reactor (such as the second fixed-bed reactor) through the pipeline with a one-way valve for hydrogenation reaction;

S2) after a period of reaction, when the activity of the hydrogenation catalyst in the first fixed-bed reactor is close to the mid-to-late stage, changing the flow direction of the hydrogen-oil mixture so that the hydrogen-oil mixture first enters the second fixed-bed reactor, and then enters the first fixed-bed reactor through the pipeline with a one-way valve;

S3) when the hydrogenation catalyst in the first fixed-bed reactor is in the deactivation stage, closing the feed valve of the first fixed-bed reactor, and replacing the deactivated hydrogenation catalyst in the first fixed-bed reactor with the regenerated hydrogenation catalyst and/or fresh hydrogenation catalyst, and at this time, the hydrogen-oil mixture only entering the second fixed-bed reactor;

S4) after the catalyst in the first fixed-bed reactor is replaced, the hydrogen-oil mixture first entering the second fixed-bed reactor, and then entering the first fixed-bed reactor where the catalyst has been replaced, through the pipeline with a one-way valve;

S5) when the hydrogenation catalyst in the second fixed-bed reactor is in the deactivation stage, closing the feed valve of the second fixed-bed reactor, and replacing the deactivated hydrogenation catalyst in the second fixed-bed reactor with the regenerated hydrogenation catalyst and/or fresh hydrogenation catalyst, and at this time, the hydrogen-oil mixture only entering the first fixed-bed reactor; and

S6) after the catalyst in the second fixed-bed reactor is replaced, repeating steps (S1) to (S5) for hydrogenation reaction.

### Example 19

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 7, and the method includes the following steps:

In this example, the low-grade heavy oil is oil sand bitumen with a kinematic viscosity (80° C.) of 9652 cSt and an API degree of 7.9. Its properties are shown in Table 4;

As shown in FIG. 7, the oil sand bitumen enters the visbreaking device for visbreaking reaction. The operating process conditions are: a reaction temperature of 417° C., a reaction pressure of 0.5 MPa, a residence time of 4 minutes, a mass conversion rate of visbreaking reaction of 22%, and the mass content of toluene insolubles in the produced oil of 0.06%.

The produced oil and hydrogen are mixed to form a hydrogen-oil mixture in gas-liquid state. The hydrogen-oil mixture enters a fixed-bed reactor filled with a hydrogenation catalyst for hydrogenation. The hydrogenation catalyst contains Ni and Mo. The hydrogenation catalyst has a pore volume of 1.1 mL/g and a specific surface area of 173 m²/g, and the volume of pores with a pore diameter greater than 50 nm in the hydrogenation catalyst accounts for 34% of the total pore volume. The pores of the hydrogenation catalyst present a bimodal distribution. The most probable pore diameter of the small pores is 24 nm, and the most probable pore diameter of the large pores is 930 nm. The hydrogenation catalyst is a sulfided catalyst. The process conditions of fixed-bed hydrogenation reaction are: a reaction pressure of 4.8 MPa, a reaction temperature of 346° C., a liquid hourly volumetric space velocity of 5.2 h⁻¹, and a volume ratio of hydrogen to oil of 1200. After the hydrogenation reaction is completed, a viscosity-reduced and upgraded oil with a kinematic viscosity (20° C.) of 297 cSt and an API degree of 19.5 is obtained. The properties of the viscosity-reduced and upgraded oil are shown in Table 4.

TABLE 4

| | Example 19 | |
|---|---|---|
| | Raw material | Product |
| Kinematic viscosity, cSt | 9652 (80° C.) | 297 (20° C.) |
| API degree | 7.9 | 19.5 |
| Olefin, % | — | 0.02 |
| CCR, % | 17.8 | 18.0 |
| Ni, μg/g | 95.5 | 78.6 |
| V, μg/g | 255.6 | 211.9 |

| | | |
|---|---|---|
| Visbreaking | Reaction | 417 |
| | temperature, ° C. | |
| | Reaction pressure, MPa | 0.5 |
| | Residence time, min | 4 |
| fixed-bed | Reaction pressure, MPa | 4.8 |
| hydrogenation | Reaction | 346 |
| | temperature, ° C. | |
| | Liquid hourly | 5.2 |
| | volumetric space | |
| | velocity, h⁻¹ | |
| | Volume ratio of | 1200 |
| | hvdrogen to oil | |

### Example 20

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 8, and the method includes the following steps:

In this example, the low-grade heavy oil is heavy oil with a kinematic viscosity (80° C.) of 9563 cSt and an API degree of 8.0, its properties are shown in Table 5 below.

As shown in FIG. 8, the heavy oil enters the visbreaking device for visbreaking reaction. The operating process conditions are: a reaction temperature of 439° C., a reaction pressure of 0.6 MPa, a residence time of 8 minutes, a mass conversion rate of visbreaking reaction of 42%, and the mass content of toluene insolubles in the produced oil of 0.04%.

The produced oil and hydrogen are mixed to form a hydrogen-oil mixture in gas-liquid state. The hydrogen-oil mixture enters a fixed-bed reactor filled with a hydrogenation catalyst for hydrogenation. The hydrogenation catalyst contains Co and Mo. The hydrogenation catalyst has a pore volume of 1.4 mL/g and a specific surface area of 118 m²/g, and the volume of pores with a pore diameter greater than 50 nm in the hydrogenation catalyst accounts for 46% of the total pore volume. The pores of the hydrogenation catalyst present a trimodal distribution. The most probable pore diameters are 21 nm, 260 nm, 1050 nm, respectively. The hydrogenation catalyst is a sulfided catalyst. The process conditions of fixed-bed hydrogenation reaction are: a reaction pressure of 9.2 MPa, a reaction temperature of 373° C., a liquid hourly volumetric space velocity of 2.8 h⁻¹, and a volume ratio of hydrogen to oil of 280. After the hydrogenation reaction is completed, a viscosity-reduced and upgraded oil with a kinematic viscosity (20° C.) of 59 cSt and an API degree of 19.6 is obtained. The properties of the viscosity-reduced and upgraded oil are shown in Table 5.

In this example, the operation steps of the fixed-bed reactors are as follows:

(S1) closing the feed valve of the second fixed-bed reactor, opening the feed valve of the first fixed-bed reactor, and using the first fixed-bed reactor for hydrogenation reaction;

(S2) when the hydrogenation catalyst in the first fixed-bed reactor is deactivated, opening the feed valve of the second fixed-bed reactor, using the second fixed-bed reactor for hydrogenation reaction, closing the feed valve of the first fixed-bed reactor, and replacing the deactivated hydrogenation catalyst in the first fixed-bed reactor with the regenerated hydrogenation catalyst and/or fresh hydrogenation catalyst;

(S3) when the hydrogenation catalyst in the second fixed-bed reactor is deactivated, opening the feed valve of the first fixed-bed reactor, using the first fixed-bed reactor for hydrogenation reaction, closing the feed valve of the second fixed-bed reactor, and replacing the hydrogenation catalyst in the second fixed-bed reactor with the regenerated hydrogenation catalyst and/or fresh hydrogenation catalyst;

(S4) repeating steps (S1) to (S3) for hydrogenation reaction.

TABLE 5

| | Example 20 | |
|---|---|---|
| | Raw material | Product |
| Kinematic viscosity, cSt | 9563 (80° C.) | 59 (20° C.) |
| API degree | 8.0 | 19.6 |
| Olefin, % | — | 0.01 |
| CCR, % | 16.7 | 16.8 |
| Ni, μg/g | 76.0 | 64.9 |
| V, μg/g | 482.3 | 430.6 |

| | | |
|---|---|---|
| Visbreaking | Reaction | 439 |
| | temperature, ° C. | |
| | Reaction pressure, MPa | 0.6 |
| | Residence time, min | 8 |
| fixed-bed | Reaction pressure, MPa | 9.2 |
| hydrogenation | Reaction | 373 |
| | temperature, ° C. | |
| | Liquid hourly | 2.8 |
| | volumetric space | |
| | velocity, h⁻¹ | |
| | Volume ratio of | 280 |
| | hydrogen to oil | |

### Example 21

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 9, and the method includes the following steps:

In this example, the low-grade heavy oil is vacuum residuum with a kinematic viscosity (80° C.) of 6369 cSt and an API degree of 7.8, Its properties are shown in Table 6.

As shown in FIG. 9, the vacuum residuum enters the visbreaking device for visbreaking reaction. The operating process conditions are: a reaction temperature of 426° C., a reaction pressure of 0.7 MPa, a residence time of 17 minutes, a mass conversion rate of visbreaking reaction of 30%, and the mass content of toluene insolubles in the produced oil of 0.04%;

The produced oil and hydrogen are mixed to form a hydrogen-oil mixture in gas-liquid state. The hydrogen-oil mixture enters a fixed-bed reactor filled with a hydrogenation catalyst for hydrogenation. The hydrogenation catalyst contains Co and W. The hydrogenation catalyst has a pore volume of 1.1 mL/g and a specific surface area of 153 m²/g, and the volume of pores with a pore diameter greater than 50 nm in the hydrogenation catalyst accounts for 39% of the total pore volume. The pores of the hydrogenation catalyst present a bimodal distribution. The most probable pore diameter of the small pores is 31 nm, and the most probable pore diameter of the large pores is 997 nm. The hydrogenation catalyst is a sulfided catalyst. The process conditions of fixed-bed hydrogenation reaction are: a reaction pressure of 7.2 MPa, a reaction temperature of 352° C., a liquid hourly volumetric space velocity of 7.6 h⁻¹, and a volume ratio of hydrogen to oil of 600. After the hydrogenation reaction is completed, a viscosity-reduced and upgraded oil with a kinematic viscosity (20° C.) of 129 cSt and an API degree of 19.3 is obtained. The properties of the viscosity-reduced and upgraded oil are shown in Table 6.

In this example, the operation steps of the fixed-bed reactor are as follows:

S1) in the initial stage of the reaction, using the two fixed-bed reactors together, the hydrogen-oil mixture first entering one of the fixed-bed reactors (such as the first fixed-bed reactor), and then entering the other fixed-bed reactor (such as the second fixed-bed reactor) through the pipeline with a one-way valve for hydrogenation reaction;

S2) after a period of reaction, when the activity of the hydrogenation catalyst in the first fixed-bed reactor is close to the mid-to-late stage, changing the flow direction of the hydrogen-oil mixture so that the hydrogen-oil mixture first enters the second fixed-bed reactor, and then enters the first fixed-bed reactor through the pipeline with a one-way valve;

S3) when the hydrogenation catalyst in the first fixed-bed reactor is in the deactivation stage, closing the feed valve of the first fixed-bed reactor, and replacing the deactivated hydrogenation catalyst in the first fixed-bed reactor with the regenerated hydrogenation catalyst and/or fresh hydrogenation catalyst, and at this time, the hydrogen-oil mixture only entering the second fixed-bed reactor;

S4) after the catalyst in the first fixed-bed reactor is replaced, the hydrogen-oil mixture first entering the second fixed-bed reactor, and then entering the first fixed-bed reactor where the catalyst has been replaced, through the pipeline with a one-way valve;

S5) when the hydrogenation catalyst in the second fixed-bed reactor is in the deactivation stage, closing the feed valve of the second fixed-bed reactor, and replacing the deactivated hydrogenation catalyst in the second fixed-bed reactor with the regenerated hydrogenation catalyst and/or fresh hydrogenation catalyst, and at this time, the hydrogen-oil mixture only entering the first fixed-bed reactor; and

S6) after the catalyst in the second fixed-bed reactor is replaced, repeating steps (S1) to (S5) for hydrogenation reaction.

TABLE 6

| | Example 21 | |
|---|---|---|
| | Raw material | Product |
| Kinematic viscosity, cSt | 6369 (80° C.) | 129 (20° C.) |
| API degree | 7.8 | 19.3 |
| Olefin, % | — | 0.01 |
| CCR, % | 19.2 | 19.2 |
| Ni, μg/g | 88.6 | 66.1 |
| V, μg/g | 182.4 | 153.7 |

| | | |
|---|---|---|
| Visbreaking | Reaction | 426 |
| | temperature, ° C. | |
| | Reaction pressure, MPa | 0.7 |
| | Residence time, min | 17 |
| fixed-bed | Reaction pressure, MPa | 7.2 |
| hydrogenation | Reaction | 352 |
| | temperature, ° C. | |
| | Liquid hourly | 7.6 |
| | volumetric space | |
| | velocity, h⁻¹ | |
| | Volume ratio of | 600 |
| | hydrogen to oil | |

### Example 22

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 10, and the method includes the following steps:

In this example, the low-grade heavy oil is oil sand bitumen with a kinematic viscosity (80° C.) of 1048 cSt and an API degree of 8.1.

As shown in FIG. 10, the oil sand bitumen enters the visbreaking device for visbreaking reaction. The operating process conditions are: a reaction temperature of 418° C., a reaction pressure of 0.8 MPa, a residence time of 7 minutes, a mass conversion rate of visbreaking reaction of 27%, and the mass content of toluene insolubles in the produced oil of 0.07%.

The produced oil is cut at 500° C. in the fractionation column to obtain a light distillate oil and a heavy distillate oil. The light distillate oil and hydrogen are mixed to form a hydrogen-oil mixture in gas-liquid state, and the hydrogen-oil mixture enters a fixed-bed reactor filled with a hydrogenation catalyst for hydrogenation reaction. The hydrogenation catalyst contains Ni and Mo. The hydrogenation catalyst has a pore volume of 1.3 mL/g and a specific surface area of 144 m²/g, and the volume of pores with a pore diameter greater than 50 nm in the hydrogenation catalyst accounts for 37% of the total pore volume. The pores of the hydrogenation catalyst present a bimodal distribution. The most probable pore diameter of the small pores is 29 nm, and the most probable pore diameter of the large pores is 990 nm. The hydrogenation catalyst is a sulfided catalyst. The process conditions of fixed-bed hydrogenation reaction are: a reaction pressure of 5.6 MPa, a reaction temperature of 338° C., a liquid hourly volumetric space velocity of 4.9 h⁻¹, and a volume ratio of hydrogen to oil of 1280. After the hydrogenation reaction, a hydrogenated liquid product is obtained. The hydrogenated liquid product is then mixed with the heavy distillate oil, to obtain a viscosity-reduced and upgraded oil with a kinematic viscosity (20° C.) of 308 cSt and an API degree of 19.8.

### Example 23

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 11, and the method includes the following steps:

In this example, the low-grade heavy oil is heavy oil with a kinematic viscosity (80° C.) of 8126 cSt and an API degree of 8.2.

As shown in FIG. 11, the heavy oil enters the visbreaking device for visbreaking reaction. The operating process conditions are: a reaction temperature of 427° C., a reaction pressure of 0.6 MPa, a residence time of 13 minutes, a mass conversion rate of visbreaking reaction of 37%, and the mass content of toluene insolubles in the produced oil of 0.03%.

The produced oil is cut at 480° C. in a fractionation column to obtain a light distillate oil and a heavy distillate oil. The light distillate oil and hydrogen are mixed to form a hydrogen-oil mixture in gas-liquid state, and the hydrogen-oil mixture enters a fixed-bed reactor filled with a hydrogenation catalyst for hydrogenation. The hydrogenation catalyst contains Co and Mo. The hydrogenation catalyst has a pore volume of 1.3 mL/g and a specific surface area of 125 m²/g, and the volume of pores with a pore diameter greater than 50 nm in the hydrogenation catalyst accounts for 41% of the total pore volume. The pores of the hydrogenation catalyst present a trimodal distribution. The most probable pore diameters are 22 nm, 215 nm, 1363 nm, respectively. The hydrogenation catalyst is a sulfided catalyst. The process conditions of fixed-bed hydrogenation reaction are: a reaction pressure of 9.6 MPa, a reaction temperature of 382° C., a liquid hourly volumetric space velocity of 4.1 h⁻¹, and a volume ratio of hydrogen to oil of 270. After the hydrogenation reaction, a hydrogenated liquid product is obtained. The hydrogenated liquid product is then mixed with the heavy distillate oil, to obtain a viscosity-reduced and upgraded oil with a kinematic viscosity (20° C.) of 48 cSt and an API degree of 19.8.

In this example, the operation steps of the fixed-bed reactors are as follows:

(S1) closing the feed valve of the second fixed-bed reactor, opening the feed valve of the first fixed-bed reactor, and using the first fixed-bed reactor for hydrogenation reaction;

(S2) when the hydrogenation catalyst in the first fixed-bed reactor is deactivated, opening the feed valve of the second fixed-bed reactor, using the second fixed-bed reactor for hydrogenation reaction, closing the feed valve of the first fixed-bed reactor, and replacing the deactivated hydrogenation catalyst in the first fixed-bed reactor with the regenerated hydrogenation catalyst and/or fresh hydrogenation catalyst;

(S3) when the hydrogenation catalyst in the second fixed-bed reactor is deactivated, opening the feed valve of the first fixed-bed reactor, using the first fixed-bed reactor for hydrogenation reaction, closing the feed valve of the second fixed-bed reactor, and replacing the hydrogenation catalyst in the second fixed-bed reactor with the regenerated hydrogenation catalyst and/or fresh hydrogenation catalyst;

(S4) repeating steps (S1) to (S3) for hydrogenation reaction.

### Example 24

This example provides a method for viscosity-reducing and upgrading of low-grade heavy oil, wherein the method for viscosity-reducing and upgrading of low-grade heavy oil utilizes the device for viscosity-reducing and upgrading of low-grade heavy oil provided in Example 12, and the method includes the following steps:

In this example, the low-grade heavy oil is vacuum residuum with a kinematic viscosity (80° C.) of 5682 cSt and an API degree of 7.7.

As shown in FIG. 12, the vacuum residuum enters the visbreaking device for visbreaking reaction. The operating process conditions are: a reaction temperature of 424° C., a reaction pressure of 0.8 MPa, a residence time of 18 minutes, a mass conversion rate of visbreaking reaction of 33%, and the mass content of toluene insolubles in the produced oil of 0.02%;

The produced oil is cut at 520° C. in a fractionation column to obtain a light distillate oil and a heavy distillate oil. The light distillate oil and hydrogen are mixed to form a hydrogen-oil mixture in gas-liquid state, and the hydrogen-oil mixture enters a fixed-bed reactor filled with a hydrogenation catalyst for hydrogenation. The hydrogenation catalyst contains Co and W. The hydrogenation catalyst has a pore volume of 1.2 mL/g and a specific surface area of 147 m²/g, and the volume of pores with a pore diameter greater than 50 nm in the hydrogenation catalyst accounts for 36% of the total pore volume. The pores of the hydrogenation catalyst present a bimodal distribution. The most probable pore diameter of the small pores is 32 nm, and the most probable pore diameter of the large pores is 1368 nm. The hydrogenation catalyst is a sulfided catalyst. The process conditions of fixed-bed hydrogenation reaction are: a reaction pressure of 6.8 MPa, a reaction temperature of 348° C., a liquid hourly volumetric space velocity of 6.6 h⁻¹, and a volume ratio of hydrogen to oil of 660. After the hydrogenation reaction, a hydrogenated liquid product is obtained. The hydrogenated liquid product is mixed with the heavy distillate oil, to obtain a viscosity-reduced and upgraded oil with a kinematic viscosity (20° C.) of 140 cSt and an API degree of 19.2.

In this example, the operation steps of the fixed-bed reactor are as follows:

S1) in the initial stage of the reaction, using the two fixed-bed reactors together, the hydrogen-oil mixture first entering one of the fixed-bed reactors (such as the first fixed-bed reactor), and then entering the other fixed-bed reactor (such as the second fixed-bed reactor) through the pipeline with a one-way valve for hydrogenation reaction;

S2) after a period of reaction, when the activity of the hydrogenation catalyst in the first fixed-bed reactor is close to the mid-to-late stage, changing the flow direction of the hydrogen-oil mixture so that the hydrogen-oil mixture first enters the second fixed-bed reactor, and then enters the first fixed-bed reactor through the pipeline with a one-way valve;

S3) when the hydrogenation catalyst in the first fixed-bed reactor is in the deactivation stage, closing the feed valve of the first fixed-bed reactor, and replacing the deactivated hydrogenation catalyst in the first fixed-bed reactor with the regenerated hydrogenation catalyst and/or fresh hydrogenation catalyst, and at this time, the hydrogen-oil mixture only entering the second fixed-bed reactor;

S4) after the catalyst in the first fixed-bed reactor is replaced, the hydrogen-oil mixture first entering the second fixed-bed reactor, and then entering the first fixed-bed reactor where the catalyst has been replaced, through the pipeline with a one-way valve;

S5) when the hydrogenation catalyst in the second fixed-bed reactor is in the deactivation stage, closing the feed valve of the second fixed-bed reactor, and replacing the deactivated hydrogenation catalyst in the second fixed-bed reactor with the regenerated hydrogenation catalyst and/or fresh hydrogenation catalyst, and at this time, the hydrogen-oil mixture only entering the first fixed-bed reactor; and

S6) after the catalyst in the second fixed-bed reactor is replaced, repeating steps (S1) to (S5) for hydrogenation reaction.

The above descriptions are only specific examples of the present disclosure and cannot be used to limit the scope of implementation of the present disclosure. Therefore, the replacement of equivalent components, or equivalent changes and modifications made according to the scope of protection of the present disclosure, should still belong to the scope of this patent. In addition, it can be freely combined and used between the technical features and technical features, between technical features and technical inventions, and between technical inventions and technical inventions in the present disclosure.

What is claimed is:

1. A method for viscosity-reducing and upgrading of low-grade heavy oil, comprising:
(a) performing a visbreaking reaction on the low-grade heavy oil raw material and controlling the content of toluene insolubles in the produced oil;
(b) mixing the produced oil obtained in step (a) with hydrogen in a gas-liquid mixer to obtain a hydrogen-oil mixture in liquid state, or mixing the produced oil obtained in step (a) with hydrogen to obtain a hydrogen-oil mixture in gas-liquid state; in the presence of a hydrogenation catalyst, performing a hydrogenation reaction on the hydrogen-oil mixture in liquid state or the hydrogen-oil mixture in gas-liquid state in the reactor, and obtaining a viscosity-reduced and upgraded oil after the reaction.

2. The method for viscosity-reducing and upgrading of low-grade heavy oil according to claim 1, wherein in step (a), the low-grade heavy oil raw material includes at least one selected from the group consisting of heavy crude oil, oil sand bitumen, atmospheric residuum and vacuum residuum.

3. The method for viscosity-reducing and upgrading of low-grade heavy oil according to claim 1, wherein in step (a), the mass content of toluene insolubles in the produced oil is controlled to be less than 1.0%.

4. The method for viscosity-reducing and upgrading of low-grade heavy oil according to claim 1, wherein in step (a), the visbreaking reaction is thermal visbreaking reaction, and the operating process conditions are: a reaction temperature ranging from 360 to 500° C., a reaction pressure ranging from 0.1 to 6.0 MPa, a residence time ranging from 1 to 120 minutes, and a mass conversion rate of the visbreaking reaction ranging from 1 to 80%.

5. The method for viscosity-reducing and upgrading of low-grade heavy oil according to claim 1, wherein the method fluffier comprises: fractionating the produced oil obtained in step (a) to obtain a light distillate oil and a heavy distillate oil; and then mixing the light distillate oil and hydrogen in a gas-liquid mixer to obtain a hydrogen-oil mixture in liquid state, or mixing the light distillate oil and hydrogen to obtain a hydrogen-oil mixture in gas-liquid state; in the presence of a hydrogenation catalyst, performing a hydrogenation reaction on the hydrogen-oil mixture in liquid state or the hydrogen-oil mixture in gas-liquid state in the reactor, and obtaining a viscosity-reduced and upgraded oil after the reaction.

6. The method for viscosity-reducing and upgrading of low-grade heavy oil according to claim 5, wherein the cut point of the light distillate oil and the heavy distillate oil is 400 to 565° C.

7. The method for viscosity-reducing and upgrading of low-grade heavy oil according to claim 5, wherein the method further comprises: mixing the hydrogenated liquid product obtained by the hydrogenation reaction with the heavy distillate oil to obtain a viscosity-reduced and upgraded oil.

8. The method for viscosity-reducing and upgrading of low-grade heavy oil according to claim 1, wherein in step (b), the hydrogenation reaction is carried out in a fixed-bed reactor, and the hydrogen-oil mixture enters the fixed-bed reactor from the top or bottom of the fixed-bed reactor.

9. The method for viscosity-reducing and upgrading of low-grade heavy oil according to claim 1, wherein in step (b), the hydrogenation reaction process conditions are: a reaction pressure ranging from 1.0 to 20.0 MPa, a reaction temperature ranging from 260 to 450° C., and a liquid hourly volumetric space velocity ranging from 0.1 to 10.0 h⁻¹; and
in the hydrogen-oil mixture in gas-liquid state, the volume ratio of hydrogen to oil is in the range of 20 to 2000.

10. The method for viscosity-reducing and upgrading of low-grade heavy oil according to claim 8, wherein in step (b), the hydrogenation reaction process conditions are: a reaction pressure ranging from 1.0 to 20.0 MPa, a reaction temperature ranging from 260 to 450° C., and a liquid hourly volumetric space velocity ranging from 0.1 to 10.0 h⁻¹; and
in the hydrogen-oil mixture in gas-liquid state, the volume ratio of hydrogen to oil is in the range of 20 to 2000.

11. The method for viscosity-reducing and upgrading of low-grade heavy oil according to claim 8, wherein there are one or more fixed-bed reactors; when there are two fixed-bed reactors, the setting mode and operation steps of the two fixed-bed reactors are either of the following two instances:
the first instance: the two fixed-bed reactors being arranged in parallel, and the inlet pipelines of the two fixed-bed reactors being respectively provided with feed valves;
(S1) closing the feed valve of the second fixed-bed reactor, opening the feed valve of the first fixed-bed reactor, and using the first fixed-bed reactor for hydrogenation reaction;
(S2) when the hydrogenation catalyst in the first fixed-bed reactor is deactivated, opening the feed valve of the second fixed-bed reactor, using the second fixed-bed reactor for hydrogenation reaction, closing the feed valve of the first fixed-bed reactor, and replacing the deactivated hydrogenation catalyst in the first fixed-bed reactor with the regenerated hydrogenation catalyst and/or fresh hydrogenation catalyst;
(S3) when the hydrogenation catalyst in the second fixed-bed reactor is deactivated, opening the feed valve of the first fixed-bed reactor, using the first fixed-bed reactor for hydrogenation reaction, closing the feed valve of the second fixed-bed reactor, and replacing the deactivated hydrogenation catalyst in the second fixed-bed reactor with the regenerated hydrogenation catalyst and/or fresh hydrogenation catalyst;
(S4) repeating steps (S1) to (S3) for hydrogenation reaction;
the second instance: the inlet and outlet pipelines of the two fixed-bed reactors being provided with a feed valve and a discharge valve respectively; a pipeline with a one-way valve being connected before the discharge valve of each fixed-bed reactor, and being connected behind the feed valve of the other fixed-bed reactor, so that materials can be introduced from the outlet of one fixed-bed reactor to the inlet of the other reactor;
S1) in the initial stage of the reaction, using the two fixed-bed reactors together, the hydrogen-oil mixture first entering the first fixed-bed reactor, and then entering the second fixed-bed reactor through the pipeline with a one-way valve for hydrogenation reaction;
S2) after a period of reaction, when the activity of the hydrogenation catalyst in the first fixed-bed reactor is close to the mid-to-late stage, changing the flow direction of the hydrogen-oil mixture so that the hydrogen-oil mixture first enters the second fixed-bed reactor, and then enters the first fixed-bed reactor through the pipeline with a one-way valve;
S3) when the hydrogenation catalyst in the first fixed-bed reactor is in the deactivation stage, closing the feed valve of the first fixed-bed reactor, and replacing the deactivated hydrogenation catalyst in the first fixed-bed reactor with the regenerated hydrogenation catalyst and/or fresh hydrogenation catalyst, and at this time, the hydrogen-oil mixture only entering the second fixed-bed reactor;
S4) after the catalyst in the first fixed-bed reactor is replaced, the hydrogen-oil mixture first entering the second fixed-bed reactor, and then entering the first fixed-bed reactor where the catalyst has been replaced, through the pipeline with a one-way valve;
S5) when the hydrogenation catalyst in the second fixed-bed reactor is in the deactivation stage, closing the feed valve of the second fixed-bed reactor, and replacing the hydrogenation catalyst in the second fixed-bed reactor with the regenerated hydrogenation catalyst and/or fresh hydrogenation catalyst, and at this time, the hydrogen-oil mixture only entering the first fixed-bed reactor; and
S6) after the catalyst in the second fixed-bed reactor is replaced, repeating steps (S1) to (S5) for hydrogenation reaction.

12. The method for viscosity-reducing and upgrading of low-grade heavy oil according to claim 1, wherein in step (b), the hydrogenation catalyst contains at least one of Mo, Ni, Co, and W, the pore volume of the hydrogenation catalyst is in the range of 0.6-1.8 mL/g, the specific surface area is in the range of 40 to 280 m²/g, and the volume of pores with a pore diameter greater than 50 nm in the hydrogenation catalyst accounts for more than 20% of total pore volume.

13. The method for viscosity-reducing upgrading of low-grade heavy oil according to claim 12, wherein the pore structure of the hydrogenation catalyst presents a bimodal distribution or a trimodal distribution; and when the pore structure of the hydrogenation catalyst presents a bimodal distribution, the most probable pore diameter of the small pores is 10 to 50 nm, and the most probable pore diameter of the large pores is 50 to 5000 nm; when the pore structure of the hydrogenation catalyst presents a trimodal distribution, the most probable pore diameters are 10 to 50 nm, 50 to 500 nm, and 500 to 5000 nm, respectively.

14. The method for viscosity-reducing and upgrading of low-grade heavy oil according to claim 12, wherein the hydrogenation catalyst is a sulfided catalyst.

15. The method for viscosity-reducing and upgrading of low-grade heavy oil according to claim 1, wherein in step (b), the viscosity-reduced and upgraded oil has a kinematic viscosity at 20° C. of less than 1200 cSt and an API degree of greater than 14.

16. A device for viscosity-reducing and upgrading of low-grade heavy oil, for carrying out the method for viscosity-reducing and upgrading of low-grade heavy oil according to claim 1, wherein:
when the raw material for the hydrogenation reaction in the method for viscosity-reducing and upgrading of low-grade heavy oil is a hydrogen-oil mixture in gas-liquid state, the device for viscosity-reducing and upgrading of low-grade heavy oil includes: a visbreaking device and a fixed-bed reactor, wherein the liquid outlet is connected to the inlet of the fixed-bed reactor through a pipeline;
when the raw material for the hydrogenation reaction in the method for viscosity-reducing and upgrading of low-grade heavy oil is a hydrogen-oil mixture in liquid state, the device for viscosity-reducing and upgrading of low-grade heavy oil includes: a visbreaking device, a gas-liquid mixer and a fixed-bed reactor, wherein the gas-liquid mixer is provided with at least a gas inlet, a liquid inlet and a liquid outlet; the liquid outlet of the visbreaking device is connected to the liquid inlet of the gas-liquid mixer through a pipeline, and the liquid outlet of the gas-liquid mixer is connected to the inlet of the fixed-bed reactor through a pipeline.

17. The device for viscosity-reducing and upgrading of low-grade heavy oil according to claim 16, wherein the device further comprises a fractionation column;
when the raw material for the hydrogenation reaction in the method for viscosity-reducing and upgrading of low-grade heavy oil is a hydrogen-oil mixture in gas-liquid state, the liquid outlet of the visbreaking device is connected to the liquid inlet of the fractionation column through a pipeline, and the light distillate oil outlet of the fractionation column is connected to the inlet of the fixed-bed reactor through a pipeline;
when the raw material for the hydrogenation reaction in the method for viscosity-reducing and upgrading of low-grade heavy oil is a hydrogen-oil mixture in liquid state, the liquid outlet of the visbreaking device is connected to the liquid inlet of the fractionation column through a pipeline, the light distillate oil outlet of the fractionation column is connected to the liquid inlet of the gas-liquid mixer through a pipeline, and the liquid outlet of the gas-liquid mixer is connected to the inlet of the fixed-bed reactor through a pipeline.

18. The device for viscosity-reducing and upgrading of low-grade heavy oil according to claim 17, wherein the device further comprises a storage tank for the viscosity-reduced and upgraded oil, and the heavy distillate oil outlet of the fractionation column and the outlet of the fixed-bed reactor are respectively connected to the storage tank for the viscosity-reduced and upgraded oil through pipelines.

19. The device for viscosity-reducing and upgrading of low-grade heavy oil according to claim 16, wherein there are one or more fixed-bed reactors; and when there are two fixed-bed reactors, the two fixed-bed reactors are arranged in parallel, each of the inlet pipelines of the two fixed-bed reactors is provided with a feed valve.

20. The device for viscosity-reducing and upgrading of low-grade heavy oil according to claim 16, wherein there are one or more fixed-bed reactor; and when there are two fixed-bed reactors, the inlet and outlet pipelines of the two fixed-bed reactors are respectively provided with a feed valve and a discharge valve; a pipeline with a one-way valve is connected before the discharge valve of each fixed-bed reactor, and is connected behind the feed valve of the other fixed-bed reactor, so that materials can be introduced from the outlet of one fixed-bed reactor to the inlet of the other reactor.
